(19) United States
(12) Patent Application Publication
(10) Pub. No.: US 2009/0025381 A1
(43) Pub. Date: Jan. 29, 2009

(54) SERVO DRIVE FOR POWER ASSISTED STEERING

(75) Inventors: Andreas Hilgert, Sinzheim (DE); Markus Angelo Ullrich, Baden-Baden (DE); Thomas Zeon Zakrzewski, Rastatt (DE); Ralph Peter Merkel, Gaggenau (DE)

Correspondence Address: DYKEMA GOSSETT PLLC, 39577 WOODWARD AVENUE, SUITE 300, BLOOMFIELD HILLS, MI, 48304-5086, US

(73) Assignee: Eaton Fluid Power GmbH, Baden-Baden (DE)

(21) Appl. No.: 12/090,786

(22) PCT Filed: Oct. 19, 2006
(86) PCT No.: PCT/EP06/09873

§ 371 Date: Jul. 25, 2008

(30) Foreign Application Priority Data
Oct. 19, 2005 (DE) 10 2005 049 959.7

(51) Int. Cl. F15B 9/08; B62D 5/06

(52) U.S. Cl. 60/443; 180/417

(57) ABSTRACT

A servo drive includes a hydraulic cylinder. The hydraulic cylinder comprises a piston that is mounted in the cylinder and that delimits two working chambers. Relief lines connected to the working chambers via control orifices may aid the definition of the right and left end positions of the piston. The control orifices are exposed by the piston in its respective end positions, thus relieving the pressure in the active working chamber. An end stop, which may be predetermined by the position of the control orifices may be formed by the pressure relief that occurs at the relevant location in the working chamber. Such measure can relieve the pressure in the hydraulic pump, for instance in end stop positions.

The invention relates to a servo drive for power-assisted steering of a motor vehicle, as well as to the hydraulic system represented by said servo drive.

Today, well-appointed motor vehicles are equipped, as a rule, with hydraulic devices for steering power enhancement, said devices amplifying the steering force imparted by the operator to the driving wheels via the steering wheel. Frequently, such systems operate on the basis of hydraulics.

Such a system has been known, for example, from document DE 196 42 837 C1. This system comprises a hydraulic cylinder that is connected to a tie rod and contains pistons that can slide back and forth in said cylinder. The piston represents an output member for moving the wheels. In the hydraulic cylinder, said piston divides two working chambers.

Each of the two working chambers is connected to a valve set, which, in inoperative position, does not admit pressurized oil to the two chambers and—during activation—admits pressurized oil, alternately, either to the one or the other working chamber of the hydraulic cylinder. In order to achieve this, a continuous-feed hydraulic pump is provided. The actuation of the valve block is derived from the movement of the steering wheel.

Each of the lines that connect the valve block to the hydraulic cylinder comprises a parallel circuit consisting of a throttle and a check valve. The check valve is oriented in such a manner that it admits the oil flow directed into the hydraulic cylinder, however, blocks the oil flow leaving the cylinder. The throttles that are connected parallel to the check valves only allow a limited oil flow out of the hydraulic cylinder. As a result of the parallel arrangement of the check valve and the throttle, it is achieved that the hydraulic oil can flow rapidly into the working chamber but only slowly out of it. This effects a damping of the steering motion and, in particular, an absorption of shocks that are exerted on the steering wheel by the wheels while the motor vehicle is moving.

The hydraulic pump operates continuously. While the operator turns the wheel up to its maximum stop and then continues to apply torque to the steering wheel against the end stop, the valve block remains in a position, in which pressure is applied to the appropriate working chamber of the hydraulic cylinder. If a continued movement of the hydraulic cylinder due to reaching an end stop is no longer possible, the maximum hydraulic pressure is thus built up in the hydraulic cylinder. In this instance, the hydraulic pump must go to zero regarding its delivery rate. In particular considering variable-rate hydraulic pumps, this leads to undesirable noise. In addition, this results in considerable power losses in the hydraulic system and thus to a heating of the oil. Consequently, larger oil coolers are required.

Considering this, it is the object of the invention to modify the hydraulic system in such a manner that said disadvantages do not occur or occur only in an attenuated form.

This object is achieved with the servo drive in accordance with claim 1, as well as with the claimed hydraulic system:

The servo drive in accordance with the invention comprises a working vessel with an output member arranged therein in a movable manner. For example, the working vessel may be configured as an elongated cylinder containing a piston that is an output member. However, the working vessel may also be represented by the working volume of a slewing drive with a slewing piston, said slewing piston then representing the output member. The servo drive may thus be any linear drive, slewing drive or even generally any rotary drive. Its working vessel is connected to two feed lines that alternately apply pressure to one or the other side of the output member—in the case of the piston from one end surface or the other end surface—in order to move the output member in a desired direction. In accordance with the invention, additional relief lines are provided, said lines being attached to the working vessel and being controlled by the output member. The control bores are respectively active, i.e., they are exposed, when the output member has reached its end position. A pressure relief in the, in fact, pressurized working volume is then possible via the relief line. The hydraulic fluid that is used may thus discharge, and the applied hydraulic pressure is reduced. As a result of this, the power losses in the hydraulic system and the noise generated by the hydraulic pump are reduced. Overall, the load on the system is reduced, which also permits the use of weaker hydraulic hoses. In addition, the decreased accumulation of heat in the system permits the size reduction of the existing oil coolers or makes them unnecessary. In addition, the load on the hydraulic pump and the V-belt frequently used for driving the hydraulic pump can be reduced. Also, it is possible to reduce the size of vibration dampers or of pressure buffers that are to be integrated in the hydraulic system.

Referring to its preferred embodiment, the servo drive in accordance with the invention is configured as a hydraulic linear drive cylinder comprising an axially movable piston that is seated in a sealed back-and-forth movable manner in the cylinder bore of the hydraulic cylinder. The feed lines terminate at locations in the interior space of the hydraulic cylinder that are preferably not reached or passed by the moving pistons. In contrast, the relief lines are preferably connected to the control bores which are exposed or blocked by the moving piston in a targeted manner. In so doing, the arrangement is preferably such that the piston, when it moves toward one of its end positions, initially closes the relief bore communicating with the relieved working chamber and then moves over said relief bore in order to expose it. When this occurs, the end position of the piston has been reached because the pressure-relief line connected to the control orifice now decreases the pressure in the pressurized working chamber. The hydraulic fluid can circulate relatively freely. The load on the pump and the generation of heat remain low.

The system in accordance with the invention makes superfluous the pressure relief valves that are otherwise necessary downstream of the hydraulic pump in power-assisted steering systems. When the end stops are reached, the formation of excess pressures on the hydraulic pump is prevented.

Preferably, the relief orifices are spaced apart in such a manner that the piston, in its center position, finds sufficient room between them. In so doing, they are preferably provided in a piston that is positioned in the center relative to the end surface, whereby the distance is as large as the desired piston stroke minus the piston thickness, said thickness having to be measured as the distance between said piston's end surfaces.

Considering a preferred embodiment, the relief line that is to lead out of the interior space is provided with a check valve which permits a flow out of the interior space but not into said space. By virtue of this measure, it is not only possible to use the power assist to move the piston into its end position but also to use the power assist to move said piston out of its end position.

Additional details of advantageous embodiments of the servo drive or of the hydraulic system are obvious from the drawings or the description, and are the subject matter of the claims.

The drawings show an exemplary embodiment of the hydraulic system in accordance with the invention. They show in

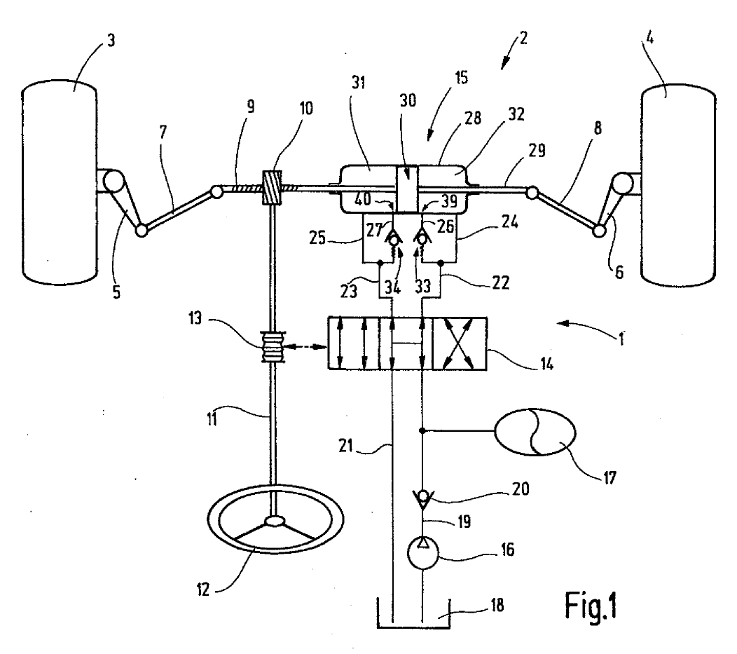

FIG. 1 a simplified schematic drawing of the hydraulic system with the servo drive in accordance with the invention; and,

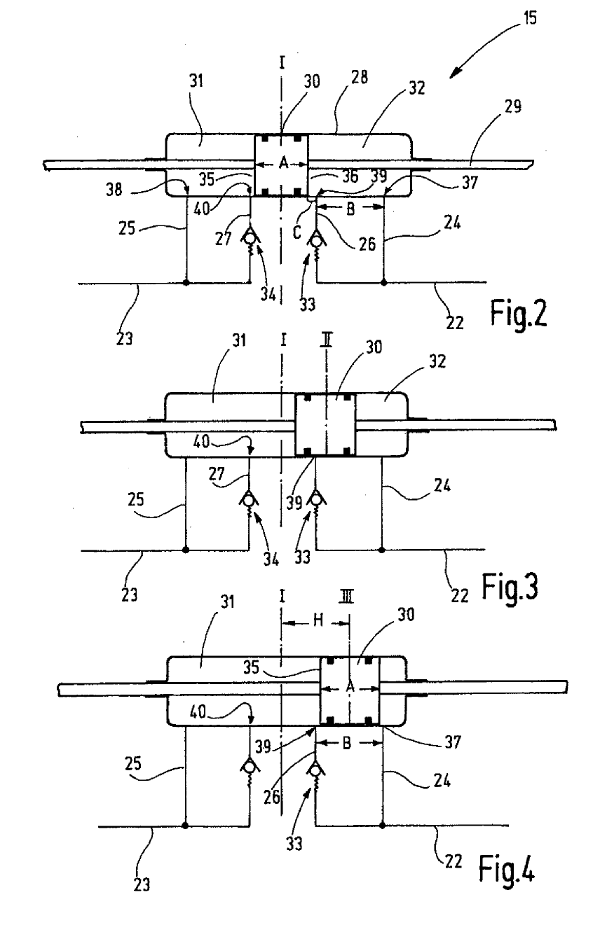

FIGS. 2 through 4 a schematic drawing of the servo drive of the hydraulic system in accordance with FIG. 1, in different operating positions.

FIG. 1 is a schematic drawing of a hydraulic system 1 of a servo drive device 2 of a not specifically illustrated motor vehicle. The power-assisted steering is used to impart a steering movement to two wheels 3, 4. In so doing, as shown in the plan view, the wheels 3, 4 pivot about the pivot axes that are essentially positioned vertically on the plane of projection. The wheels 3, 4 are rotatably supported on hub carriers that comprise steering levers 5, 6 that are pin-connected—via tie rods 7, 8—to the two ends of a rack 9. The rack 9 meshes with a pinion 10. Via a steering column 11, said pinion is connected to a steering wheel 12 which is used by the operator to steer the wheels 3, 4. The steering column 11 comprises a torsionally elastic element 13 that permits a limited relative rotation between the pinion 10 and the steering wheel 12. The degree of the relative rotation is a function of the torque transmitted between the steering wheel 12 and the pinion 10, and controls a servo valve 14 that belongs to the hydraulic system 1. In addition, the hydraulic system 1 comprises a servo drive 15, a hydraulic pump 16, a pressure accumulator 17, as well as a hydraulic reservoir 18. Through a line 19, the hydraulic pump 16 conveys hydraulic fluid through a check valve 20 past the pressure accumulator 17 and to the servo valve 14. From the servo valve 14, a line 21 leads back to the hydraulic reservoir 18. In addition, the servo valve 14 is connected to the servo drive 15 via the lines 22, 23. The lines 22, 23 are associated with feed lines 24, 25 and relief lines 26, 27.

The servo valve 14 is a ¾-way valve, which—in center position when the element 13 is not twisted in any direction of rotation—offers straight passage from the line 19 to the line 22 and from the line 21 to the line 23. In addition, both paths are short-circuited between each other. If the element 13 is rotated in one or the other direction, the lines 19, 21; 22, 23 are connected to each other in a straight line or intersected in order to generate a force with the servo drive 15, said force supporting the force exerted on the rack 9 via the pinion 10.

The servo drive 15 comprises a working vessel 28, for example configured as a cylindrical pipe with closed ends. A piston rod 29 connected to an output member 30 extends through the two closures. In the present case, said output member is a piston with a sealed outside circumference, which, however, is supported in the working vessel 28 or the cylinder in a manner so that it can be moved back and forth. The piston 30 divides the working chambers 31, 32 in the cylinder 28, said chambers being respectively connected to the feed lines 25, 24. In addition, the relief lines 27, 26 terminate in the working chambers 31, 32. The relief lines 26, 27 contain check valves 33, 34 that permit a flow out of the interior space of the working vessel or cylinder 28, but not into the latter. Instead of the check valves, it is also possible to provide pressure control valves which adjust the pressure in the working chamber to a definable value as soon as said valves have been cleared. As a result of this, it can be achieved that the servo effect at the end stop will not drop off abruptly but will be retained in a reduced manner.

FIG. 2 is a separate schematic drawing of the servo drive 15. Its piston 30 is in a center position I where the two working chambers 31, 32 have approximately the same size. The end surfaces 35, 36 of the piston 30 limit said piston's working chambers 31, 32. These surfaces are located at a distance A from each other. The piston 30 can move in the working vessel or cylinder 28 out of its center position I into an end position III, as shown by FIG. 4, whereby said piston moves through a stroke H. The cylindrical pipe which forms the working vessel 28 is longer than double the stroke H. The feed lines 24, 25 terminate at locations 37, 38 in the working chambers 31, 32 which are passed by the piston 30 on its path. As opposed to this, the relief lines 26, 27 on the control orifices 39, 40 branch off the working vessel or cylinder 28, said orifices being covered by the piston 30, and can be covered and thus closed and exposed in a targeted manner. In so doing, the distance B of the location 37 from the control orifice 39 is greater than the distance A (see FIG. 4). Likewise, the distance between the location 38 and the control orifice 40 is greater than the distance A.

Furthermore, the distance C of the end surface 36 from the control orifice 39 of the piston 30 being in center position I preferably is equal to the difference between the stroke H and the distance A.

The servo drive 15 is symmetrical with respect to a center plane that is defined by the piston 30 positioned in the center position I and extends perpendicular to the axis that has been pre-specified by the piston rod 29.

The in-so-far described hydraulic system 1 and the power-assisted steering 2 work as follows:

FIG. 1 shows the status of the hydraulic system 1 during straight travel. The servo valve 14 connects the lines 19, 22, 23, 21 to each other. The hydraulic fluid, which is conveyed at increasingly greater or lesser volumetric delivery by the hydraulic pump 16, can thus be delivered—without the application of pressure—via the line 21 into the hydraulic reservoir. The servo drive 15 is in the position in accordance with FIG. 2. The same, relatively low pressure prevails in both working chambers 31, 32.

Now, it is assumed that the operator wishes to steer the vehicle to the left. Referring to the conditions in FIG. 1, this requires a shift of the rack 9 to the right, this being initiated by a left turn of the steering wheel 12. In so doing, the element 13 yields in an elastic manner, as a result of which the pilot valve 14 becomes active in accordance with the field shown on the right of the line schematic. In so doing, pressure is applied to the left working chamber 31 in FIG. 1; and the piston rod 29 and the rack 9 are moved to the right in order to turn the wheels 3, 4 to the left. Starting with the position I of the piston 30 as shown by FIG. 2, said piston is moved into the position II in accordance with FIG. 3. Pressure is applied to the working chamber 31, while pressure is relieved in the working chamber 32. The hydraulic fluid flows through the line 23 and the feed line 25 into the working chamber 31. The check valve 34 remains closed.

When it is moved to the right, the piston 30 initially covers the control orifice 39. The hydraulic fluid that has been displaced by the piston 30 may then discharge into the hydraulic reservoir 18 via the feed line 24 and the line 22, as well as the servo valve 14 and the line 21.

If the vehicle is to be steered in the opposite direction, the servo valve 14 reverses, and the working chamber 32 is supplied with hydraulic fluid via the feed line 24, while the hydraulic fluid may flow out of the working chamber 31 via the feed line 25 and the line 23.

If the initially described left turn of the wheels 3, 4 is maintained and continued to the left by continuous turning of the steering wheel 12 to the left until the maximum wheel turning position is reached, the piston 30 continues to move farther to the right until it has reached the position III as shown by FIG. 4. In this position, said piston's end surface 35 exposes the control orifice 39. Via the feed line 25, the servo valve continuously—and still—delivers hydraulic fluid to the working chamber 31. However, as soon as the piston 30 has moved past the control orifice 39 and its end surface 35 is thus positioned on the right next to the control orifice 39, the hydraulic fluid can flow—via the relief line 36, the check valve 33, the line 22, the servo valve 14 and the line 21—out of the working chamber 31 into the hydraulic reservoir 18. Consequently, the hydraulic pressure in the working chamber 31 drops to a lower value as soon as the piston 30 has exposed the control orifice 39. In so doing, said piston stops, i.e., it has reached its hydraulically defined stop position. The stop position is fixed by the position of the control orifice 39. The left stop position is analogously fixed by the position of the control orifice 40. The distances of the control orifices 39, 40 from each other, plus the distance A of the piston 30, define the maximum stroke of the piston to be covered from the right stop to the left stop.

The hydraulic pump 16 is relieved in stop position due to the pressure reduction occurring in the end stop position of the piston 30 and due to the connection established via the relief line 26 between the pressurized line 23 and the pressureless line 23. Noise formation on the hydraulic pump 16 or on any other hydraulic components is minimized. The pressure accumulator 17 may potentially be omitted, or it may be minimized regarding its size or capacity. By reducing the otherwise occurring heat generation, the oil cooler may be omitted or its size may be minimized.

The control orifice 39 fixes the right end position of the piston path. Analogously, the control orifice 40 fixes the left end position of the path of the piston 30. If said position is cleared because the piston 30—while pressure is being applied to the line 22—has reached its left maximum position, the check valve 34 opens, and the pressure relief in the working chamber 32 occurs via the relief line 27, as a result of which—depending on the position of the pressure relief bore—the power-assisted movement of the piston does not take place, and a further movement of the piston rod may still only take place under the influence of a continued action of the steering force exerted by the operator. The load is removed from the hydraulic pump 16.

A servo drive in accordance with the invention comprises a hydraulic cylinder containing a piston 30 which divides two working chambers 31, 32. Relief lines 26, 27 that are connected to the working chambers 31, 32 via control orifices 39, 40 are used to fix the right and the left end positions of the piston 30. The control orifices 39, 40 are respectively exposed by the piston 30 in said piston's end position and then lead to a pressure relief in the active working chamber. Consequently, an end stop pre-specified by the position of the relief orifices 39, 40 is created, said end stop being due to the pressure relief occurring at the relevant location in the active working chamber. This measure relieves the hydraulic pump 16, in particular in the end stop positions.

1.-17. (canceled)

18. A servo drive for a steering system of a motor vehicle, comprising:
a working vessel which encloses an interior space that is sealed toward the outside for the accommodation of hydraulic fluid;
an output member that is movably arranged in the interior space, said member dividing the interior space into two working chambers;
two feed lines which are respectively connected to one of the two working chambers; and,
two relief lines that are connected to the interior space to the control openings of the working vessel, said control openings being controlled by the output member.

19. The servo drive in accordance with claim 18, wherein the working vessel is a hydraulic cylinder.

20. The servo drive in accordance with claim 18, wherein the output member is a piston.

21. The servo drive in accordance with claim 18, wherein the output member has two end surfaces that face away from each other, one of said surfaces limiting one of the working chambers and the other limiting the other of working chambers.

22. The servo drive in accordance with claim 21, wherein the control openings are configured such that the output member is positioned between two control orifices when said output member is in a center position.

23. The servo drive in accordance with claim 21, wherein the control openings are arranged at a distance from each other, said distance being greater than the distance of the two end surfaces of the output member from each other.

24. The servo drive in accordance with claim 18, wherein the position of one control orifice relative to the center position of the output member is fixed in such a manner that its distance from the end surface of the output member is equal to the difference between the desired maximum stroke of the output member and the distance of the end surfaces from each other.

25. The servo drive in accordance with claim 18, wherein the feed lines terminate at locations in the interior space, said locations' distance from each other being greater than double the maximum stroke of the output member.

26. The servo drive in accordance with claim 21, wherein the distance at the location where the feed line terminates in the interior space is greater from the adjacent control openings than the distance of the end surfaces from each other.

27. The servo drive in accordance with claim 18, wherein a relief valve is connected to, or arranged on, the relief line.

28. The servo drive in accordance with claim 27, wherein the relief valve comprises a check valve.

29. The servo drive in accordance with claim 27, wherein the relief valve comprises a pressure-control valve that defines the end stop pressure.

30. The servo drive in accordance with claim 28, wherein the check valve is oriented to permit a flow directed out of the interior space.

31. The servo drive in accordance with claim 18, wherein the positions of the control openings relative to a center position of the output member are fixed symmetrically.

32. The servo drive in accordance with claim 18, wherein respectively the relief lines and the feed lines terminating in the same working chamber when the output member is in the center position are connected to each other.

33. A hydraulic system for a power-assisted steering of a motor vehicle comprising
a hydraulic pump;
a servo valve connected to the hydraulic pump; and,
a servo drive connected to the servo valve;
wherein the servo drive comprises:
a working vessel that encloses an interior space that is sealed toward the outside for the accommodation of hydraulic fluid;
an output member that is movably arranged in the interior space, said member dividing the interior space into two working chambers;
two feed lines that are respectively connected to one of the two working chambers; and,
two relief lines that are connected to the interior space to the control openings of the working vessel, said control openings being controlled by the output member.

34. The hydraulic system in accordance with claim 33, wherein the hydraulic pump comprises a variable-rate pump.
